(19) United States
(12) Patent Application Publication
(10) Pub. No.: US 2011/0050756 A1
(43) Pub. Date: Mar. 3, 2011

(54) USE OF DISPLAYS IN LOW-POWER AND LOW-COST ELECTRONIC SYSTEMS

(75) Inventors: Micheal Cassidy, Dublin (IE); Alain Briancon, Poolesville, MD (US)

(73) Assignees: NTERA, INC., Radnor, PA (US); NTERA LIMITED, Dublin (IE)

(21) Appl. No.: 12/874,660

(22) Filed: Sep. 2, 2010

Related U.S. Application Data
(60) Provisional application No. 61/239,203, filed on Sep. 2, 2009.

(51) Int. Cl. G09G 5/10; G09G 5/00

(52) U.S. Cl. 345/690; 345/211

(57) ABSTRACT

The application describes a device using a display and a method to control the display device in a low power consumption manner. The device may be geared towards disposable use and manufactured using printed electronics techniques. A simple controller system may adapt the state of the device based on type and status of power source(s), or with respect to application specific requirements within the life-cycle of the device.

This application claims the benefit of U.S. provisional application No. 61/239,203, which was filed Sep. 2, 2009 and is incorporated herein by reference as if fully set forth.

### FIELD OF INVENTION

This application relates to electronic devices having displays that may be present in low-power and/or low-cost electronic systems, the systems and related methods.

### BACKGROUND

Display devices are finding applications in new and emerging markets. Many of these applications, such as smartcards with embedded displays, smart packaging, sensors, watches, printed systems on substrate, smart labels, passports, disposable diagnostic systems and many other battery powered or power scavenging systems may be enhanced when the system operates efficiently from a low-voltage and/or low power source, such as a printed battery, photovoltaic cell, thermoelectric, piezoelectric or a low-power RF sources such as a NFC reader.

Many of these devices are disposable. Many of these devices do not allow the end user and/or the manufacturer to change/replace the power source of the device after the original device manufacturing. The creation of these low power display devices using low cost printed display electronics brings challenges that are unique to the printed electronic and not encountered by traditional displays technologies such as CRT, LED, LCD or OLED.

### SUMMARY

In an aspect, the invention relates to an electronic system. The electronic system includes an electronic device and an associated power source including at least one individual power source. The electronic device includes having a controller system and a display including at least one addressable element. The display is operably connected to the controller system. The associated power source is operably connected to the controller system. The controller system includes a processor and a computer-readable medium. The processor is operably connected to the computer-readable medium. The computer-readable medium includes processor executable instructions for determining at least one status selected from the group consisting of life-cycle status of the electronic device, status of the display, and status of an interaction with the electronic device. The computer-readable medium also includes processor executable instructions for producing a waveform set having one or more individual waveforms based on at least one of the life-cycle status of the electronic device, the status of the display, or the status of an interaction with the electronic device. The computer-readable medium also includes processor executable instructions for applying the waveform set to the display.

In an aspect, the invention relates to a method of managing power consumption in an electronic system. The electronic system includes an associated power source having at least one individual power source and an electronic device. The electronic device includes a display and a controller system. The display is operably connected to the controller system and the controller system is operably connected to the associated power source. The display includes at least one addressable element. The control system includes a processor and a computer-readable medium having processor executable instructions for conducting the method. The processor is operably connected to the computer readable-medium. The method includes determining at least one status selected from the group consisting of life-cycle status of the electronic device, status of the display, and status of an interaction with the electronic device. The method also includes producing a waveform set having one or more individual waveform based on at least one of the life-cycle status of the electronic device, the status of the display, and the status of an interaction with the electronic device. The method also includes applying the waveform set to the display.

In an aspect, the invention relates to an electronic device. The electronic device includes a controller system, a display including at least one addressable element, and at least one of a power source or an energy harvesting component. The display is operably connected to the controller system. At least one of the power source or energy harvesting component are operably connected to the controller system. The controller system includes a processor and a computer-readable medium. The processor is operably connected to the computer-readable medium. The computer-readable medium includes instructions for determining at least one status selected from the group consisting of life-cycle status of the electronic device, status of the display, and status of an interaction with the electronic device. The computer-readable medium also includes instructions for producing a waveform set having one or more individual waveforms based on at least one of the life-cycle status of the electronic device, the status of the display, and the status of an interaction with the electronic device. The computer-readable medium also includes instructions for applying the waveform set to the display.

### BRIEF DESCRIPTION OF THE DRAWINGS

The following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 illustrates an electronic system having a printed electronic device a power source.

FIG. 2 illustrates a system having an electronic device with a display and multiple power sources.

FIG. 3 illustrates a life cycle of a system, different control regimes the controller system may experience and associated operations.

FIG. 4a illustrates a controller system.

FIG. 4b illustrates a method that may be implemented by the controller system of FIG. 4a.

FIG. 5a illustrates a controller system.

FIG. 5b illustrates a method that may be implemented by the controller system of FIG. 5a.

### DETAILED DESCRIPTION OF THE PREFERRED EMBODIMENTS

Certain terminology is used in the following description for convenience only and is not limiting.

As used herein, “operably connected” means that elements within the system are connected physically or through a remote connection such that they are functionally connected. As a non-limiting example, a remote connection may be through a localized Radio Frequency link.

The words “a” and “one,” as used in the claims and in the corresponding portions of the specification, are defined as including one or more of the referenced item unless specifically stated otherwise. The phrase “at least one” followed by a list of two or more items, such as “A, B, or C,” means any individual one of A, B or C as well as any combination thereof.

Embodiments herein provide an electronic device having a display. Embodiments herein provide systems including an electronic device having a display. In some embodiments, the electronic device may operate under conditions or low power or variable power sources. The individual power sources may be physically embedded on or in the electronic device or may be remote from the electronic device. Some embodiments provide energy harvesting components within an electronic device to harvest power from remote power sources when a remote power source is part of an electronic system. A remote power source may be in the vicinity of the electronic device. The display may be any kind of display, and in some embodiments is a bistable display. A bistable display may be an electrochromic display. In some embodiments, an electronic system also includes a sensor. The sensor may be located at a position within the electronic system other than on the electronic device, or embedded on or in the device.

The electronic device may be a disposable, low cost or disposable and low cost. However, some embodiments may include durable electronic devices, electronic devices that are other than low cost and electronic devices that are durable and other than low cost.

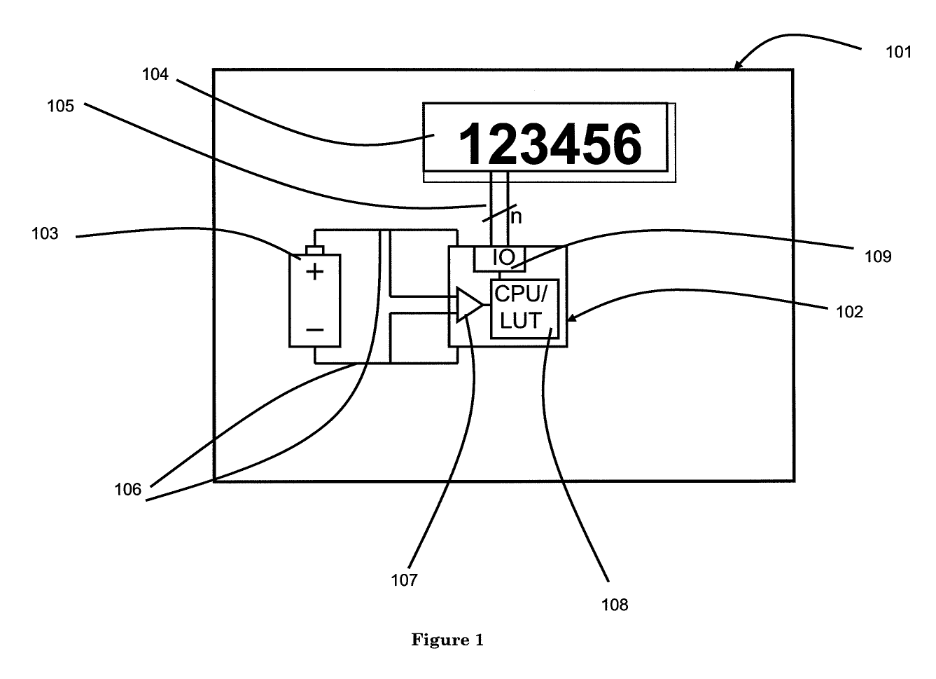

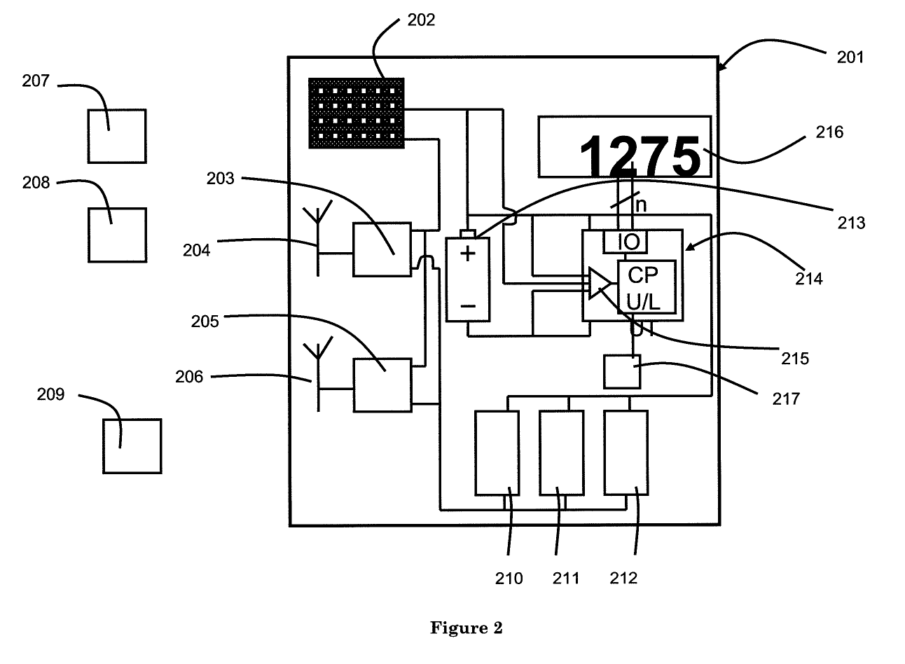

As described with reference to FIGS. 1 and 2, below, an electronic system may include a single power source or multiple (more than one) power sources. Also, as set forth above, a power source may be located on or in the device, or remotely from the device. The individual power source(s) of an electronic system may be referred to collectively as an associated power source. Examples of powers sources that may be located on or in the electronic device include but are not limited to a primary battery, a secondary battery, a capacitor, a piezoelectric cell, and an electrochemical system. Examples of power sources that may be located remote from the electronic device include but are not limited to an NFC reader and WIFI access point, an FM broadcast station, a TV broadcast station, light, and vibration (e.g., from sources such as a motor or a machine).

Referring to FIG. 1, an electronic device 101 is illustrated. The electronic device 101 includes a controller system 102, a power source 103 and a display 104. The display 104 may be a bistable, electrochromic display. The display 104 is connected to the controller system 102 through a bus system 105. The power source 103 is connected to the controller system 102 through interconnection structure 106. A voltage sensor 107 may be provided to measure the voltage available to the controller system 102. Control, driver, and user interface logic may be implemented as code by CPU 108 within the controller system. An input and/or output may be included as indicated at IO 109. The controller system may include one or more computer-readable medium. The computer-readable medium may store information or instructions. The information or instructions may relate to at least one of controller functions, driver functions or user interface logic.

Referring to FIG. 2, an electronic system including a manner of integrating multiple power sources as the associated power source is illustrated. An electronic device 201 includes the following energy harvesting components: a solar cell 202, a RF rectifier 203 connected to an antenna system 204, an RFID chip 205 connected to another antenna system 206. The electronic devices 201 may be implemented to be low cost, disposable or low cost and disposable. During operation of the system, the RF rectifier may be able to capture power emitted from a NFC reader 207 and a WIFI access point 208. During the programming of the system, its RFID will pickup power and signal from RFID reader 209. The electronic device includes a super-capacitor 210, a secondary battery 211, and an electrochromic display used as a charge reservoir 212. The three elements may be charged on an as needed basis from the energy harvesting components. The electronic device includes a primary battery 213, a controller system 214 that hosts a power sensor 215 that senses the status of the different power components. A display 216 is also included in this electronic device. The charge reservoir 212 and the display 216 may be realized with the same physical display. Sensor 217 may be provided. The sensor 217 may be a temperature sensor that senses the ambient temperature. Another type of sensors may be provided as sensor 217 or in addition to it. A plurality of sensors may be provided. The other type of sensors may be but are not limited to pressure, moisture, altitude sensors. A UI or control switch (not shown) may be provided.

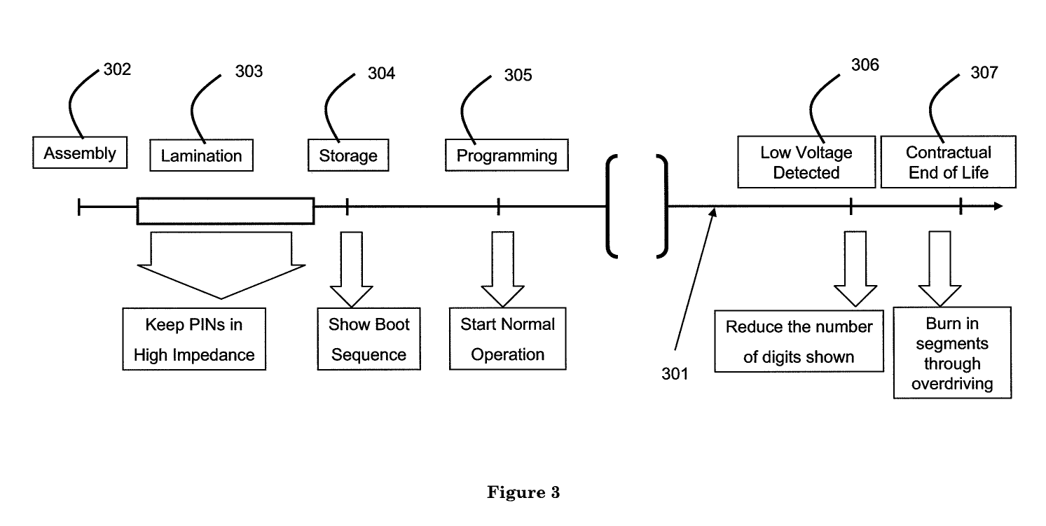

Referring to FIG. 3, a timeline 301 that may be experienced by an electronic device is illustrated. The timeline 301 spans from the assembly 302 of the system. During lamination 303, which may be detected by sensing the ambient temperature, the controller system may keep the PINs in high impedance to avoid using power and exposing the display to long period where current is flowing. After lamination is complete, when the device is ready for storage 304, a boot sequence may be triggered to show that the system was successfully manufactured. The boot sequence may also start a clock. The clock may be a low precision clock. The programming 305 starts the normal operation of the device. The programming 305 may be done through RFID programming. If during the operation of the electronic device, a low voltage operation is detected, the electronic device may leave some segments off. At a user defined end of life (e.g., the contractual end of life 307) for the electronic device, the electronic device may be overdriven to indicate it is no longer working. A user defined end of life may be measured using the timer started at 304.

An electronic device in any of the embodiments herein may also include a computer-readable medium. The term “computer-readable medium” includes but is not limited to a register, a cache memory, a read-only memory (ROM), a semiconductor memory device such as a Dynamic Random Access Memory (D-RAM), Static RAM (S-RAM), or other RAM, other volatile or non-volatile memory, or other type of device for electronic data storage. The memory may be non-volatile (for instance FLASH, EEPROM) inside the controller system. A “memory device” is a device configurable to read and/or write data to/from one or more computer-readable media. The computer-readable medium may include processor executable instructions for implementing one or more method herein.

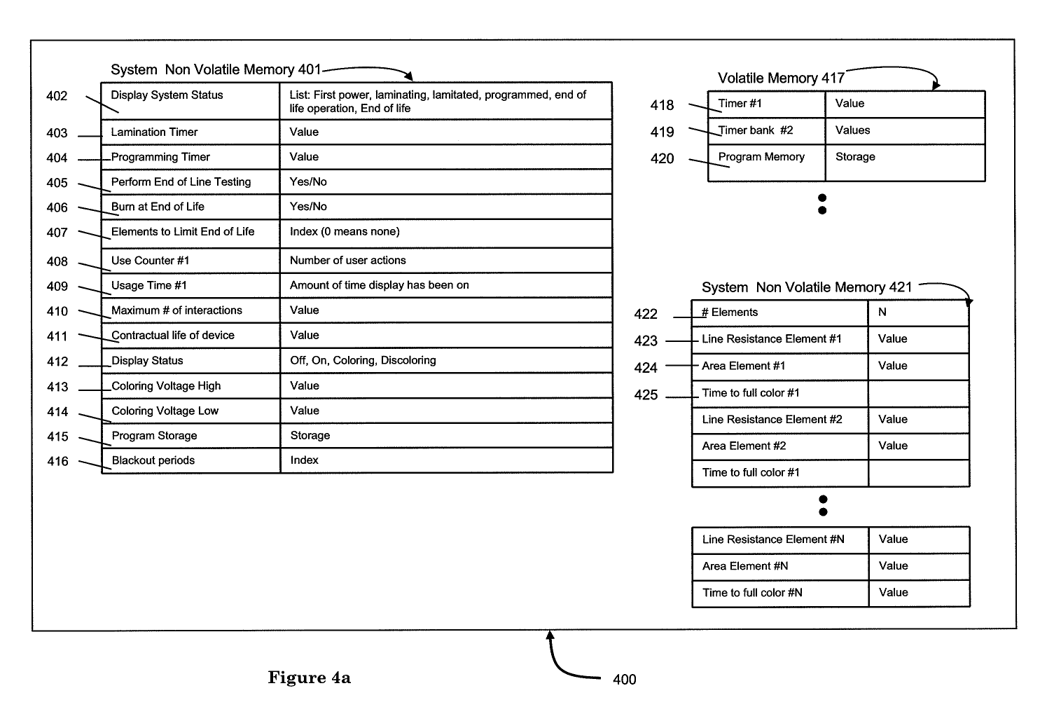

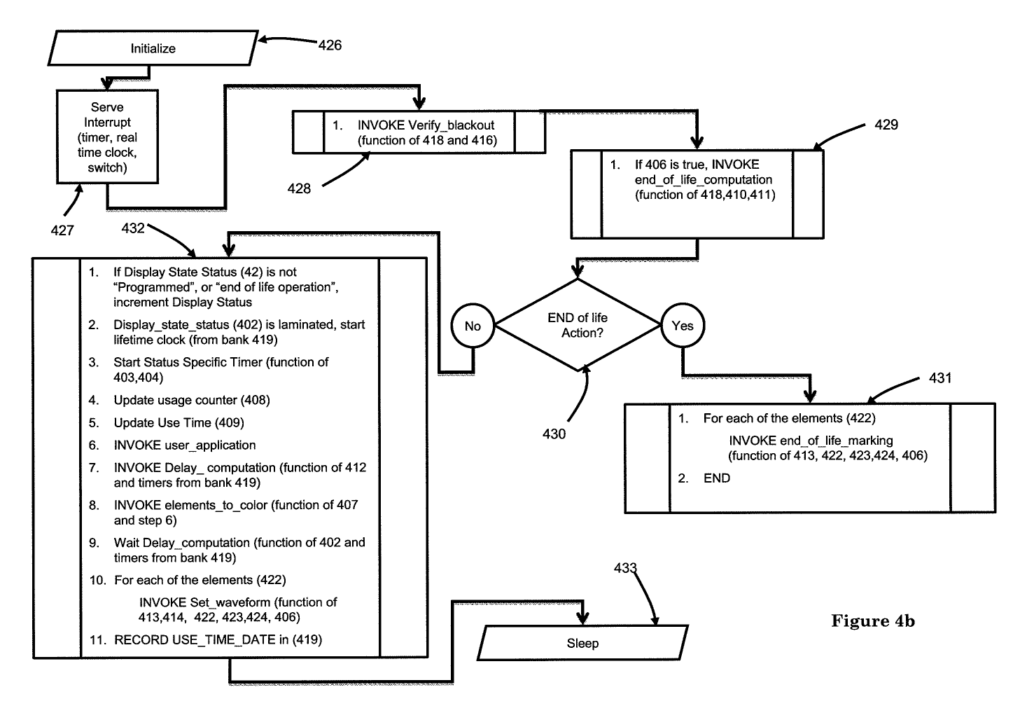

FIGS. 4a to 4b illustrate a method for waveform control for an electronic device and register/memory information that may be provided for performance of the method. Referring to FIG. 4a, the controller system 400 may run a program stored in the program storage 415 of the non-volatile memory 401 and use a program memory 420 of the volatile memory 417. The non-volatile memory 401 includes storage for a logical display system status 402, a lamination timer 403 used to block interaction during the hot lamination of the system, a programming timer 404 that allows all keying and customization of the system to be performed, a semaphore 405 to indicate whether end of line testing should be automatically triggered by the system, a semaphore 406 to indicate if a overriding function should take place at the end of the life of the device, an index 407 of the elements that should be left off in case of low power configuration, a usage counter 408, a usage time counter 409 that could be based on the output of a low precision clock or high precision real-time-clock, a memory 410 capturing the maximum numbers of interactions allowed by the system, a memory 411 capturing the contractual amount of time the system is set to, a logical representation 412 of the display, the high voltage 413 and low voltage 414 needed to drive coloring of elements, and an index 416 to the black out periods where the display is to remain discolored.

As illustrated in FIG. 4a, some data may be stored in the volatile memory 417. The data in the volatile memory 417 may include timer 418 and a bank of timers 419 and the program memory 420.

An additional non volatile memory 421 may store information about the display, namely the number 422 of elements and for each one, the line resistance 423 and the area to color 424. Each of memories 401, 417 and 421 could stored in distinct computer-readable media or combined as appropriate within one or more computer-readable media. Memories 401, 417 and 421 are examples of computer-readable mediums that may be included in an electronic device.

Referring to FIG. 4b, a routine is illustrated in the form of a flowchart, which provides a method of utilizing the controller system 400 (FIG. 4a) as follows. Reference characters within a block within FIG. 4b refers to characters illustrated in FIG. 4a. After an initialization phase at step 426, the program waits for an interrupt. When the interrupt is detected and/or classified at step 427, the controller system ensures that the electronic devices is not in a black out period at step 428. In step 428, the timer 418 and/or the blackout periods 416 may be accessed to determine whether the system is in blackout. In step 429, conditions including the timer 418, the maximum number of interactions 410 and/or the contractual life 411 of the electronic device may be accessed to assess the system in comparison to end of life criteria. At step 430, a test is conducted to determine if the electronic device is at the end of life. If it is determined at step 430 that “yes” the electronic device is at the end of life, the elements of the displays are marked according to step 431. Step 431 may include utilizing the information of at least one the coloring voltage high value 413, the number of elements 422, the line resistance element 423, the area element 424, or the burn at end of life 406 controls of controller system 400. If it is determined at step 430 that “no” the electronic device is not at the end of life, step 423 may be performed. Step 423 may include at least one of the following: incrementing the display status if the display status 402 indicates that the display is not “programmed” or “end of life operation;” starting a lifetime clock from bank 419 if the display system status 402 is “laminated;” starting a status specific clock depending on the status of one or more of the lamination timer 403 or the programming timer 404; updating the usage counter 408; updating the usage time 409; invoking a user application; invoking a delay, which may be a function of display status 412 and timers in timer bank 419; or invoking a waveform set that may be a function of at least one of the coloring voltage high value 413, the coloring voltage low value 414, the number of elements N 422, the line resistance element value 423, the area element value 424, or the burn at end of life index 406. As illustrated, step 432 may be conducted to update counters, compute the waveform parameters for each individually addressable element and drive the different connections between controller system 400 and a display (see the display examples in FIGS. 1 and 2) based on the information collected, processed or accessed. The time and date that step 423 is performed may be recorded into memory 419. At step 433, the controller system may be placed into sleep mode while awaiting the next interrupt.

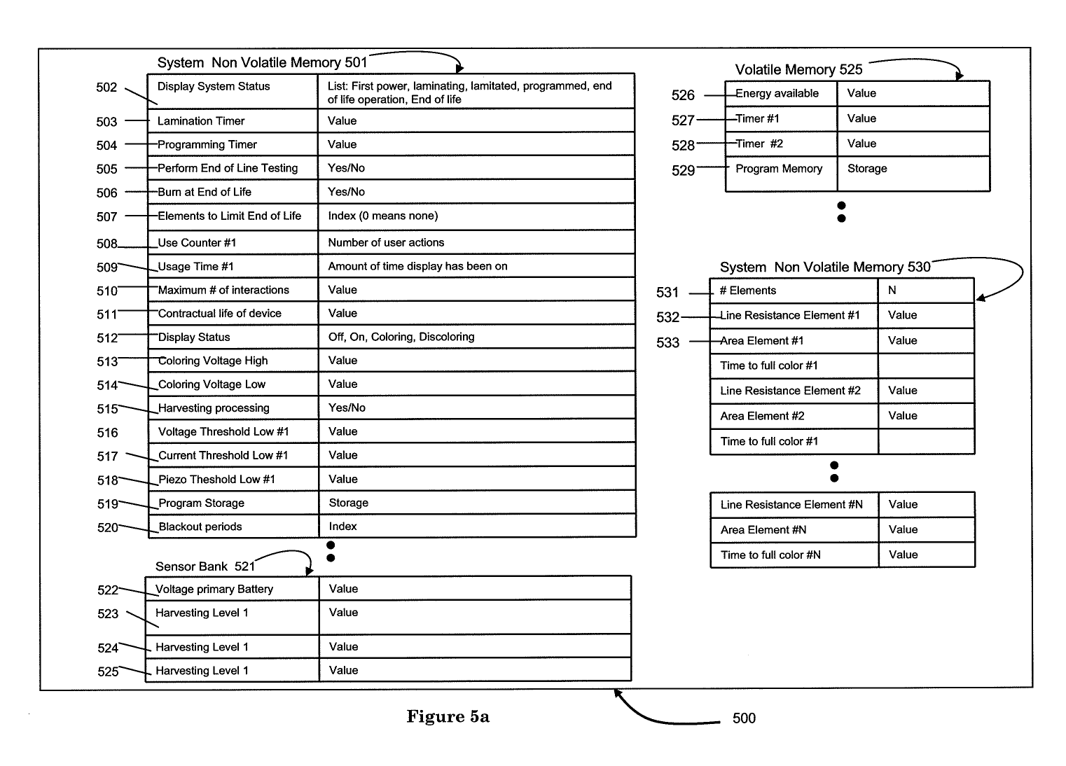

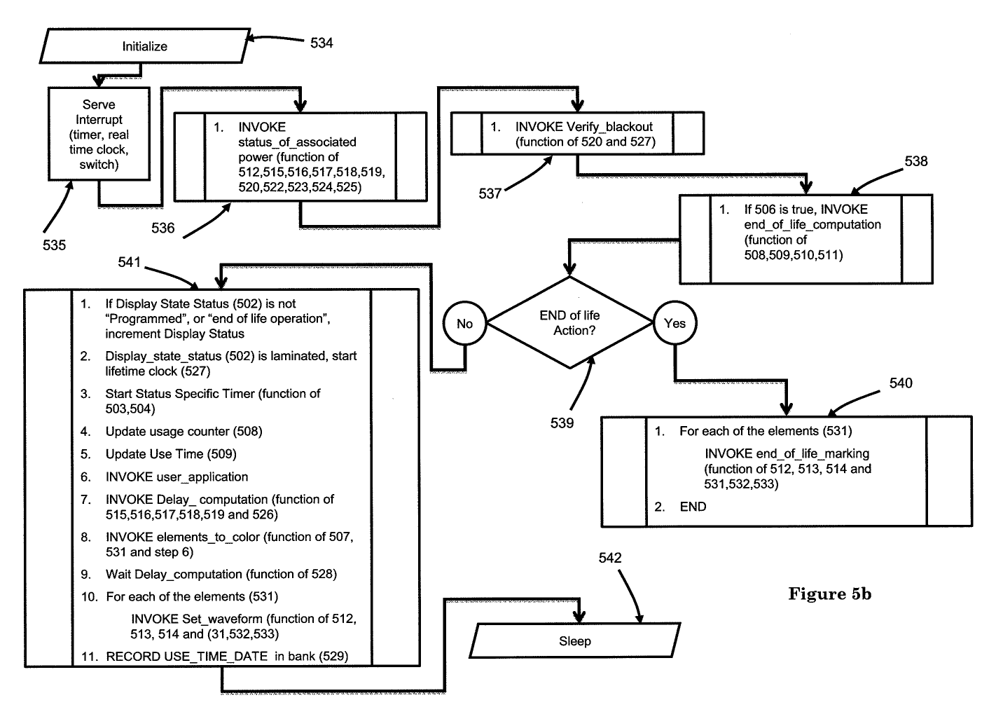

FIGS. 5a to 5b illustrate a method for waveform control for an electronic device and register/memory information that may be provided for performance of the method. The method and register/memory information illustrated in FIGS. 5a to 5b is designed for a system that includes a sensor. Referring to FIG. 5a, the controller system 500 runs a program stored into program storage 519 of non-volatile memory 501 and uses program memory 529 of non volatile memory 525. The non-volatile memory 501 includes storage for at least a logical display system status 502, a lamination timer 503 that may be used to block interaction during the hot lamination of the system, a programming timer 504 that may allow keying and customization of the system to be performed, a semaphore 505 to indicate whether end of line testing should be automatically triggered by the system, a semaphore 506 to indicate if a overriding function should take place at the end of the life of the device, an index 507 of the elements that should be left off in case of low power configuration, a usage counter 508, a usage time counter 509 that can be based on the output of a low precision clock or high precision real-time-clock, a memory 510 capturing the maximum numbers of interactions allowed by the system, a memory 511 capturing the contractual amount of time the system is set to, a logical representation 512 of the display, a high voltage 513 and a low voltage 514 needed to drive coloring of elements, a semaphore 515 to determine whether harvesting processing is to take place, a low voltage threshold 516 below which the system is considered to have a weak associated power, a low current threshold 517 below which the electronic device is considered to have a weak associated power, a piezoelectric energy threshold 518 below which the system is considered to have weak associated power, and an index 520 to the black out periods where the display is to remain discolored.

Some of the data may be stored in volatile memory 525. Volatile memory 525 may include data that are the result of a computation of the energy available 526, or the timers 527, 528. Sensor bank 521 stores information regarding data collected from one or more sensors.

Additional non-volatile memory 530 stores information about the display, for example, the number 531 of elements and for each element, the line resistance 532 and the area to color 533. Each of memories 501, 525, 530 and sensor bank 521 could be stored in distinct computer-readable medium or combined with one or more of the others as appropriate. Memories 501, 525 and 530, and sensor bank 521 are examples of computer-readable mediums that may be included in an electronic device.

Referring to FIG. 5b, a routine is illustrated in the form of a flowchart, which provides a method of utilizing the controller system 500 (FIG. 5a) as follows. Reference characters within a block within FIG. 5b refer to characters illustrated in FIG. 5a. After an initialization phase at step 534, the program waits for an interrupt. When an interrupt is detected and/or classified at step 535, the controller system assesses the status of the associated power source at step 536, and ensures that the electronic device is not in black out period at step 537. The status of the associated power source at step 536 may be determined by assessing at least one of the display status 512 information, the harvesting processing 515 status, the voltage threshold 516 value, the current threshold 517 value, the piezoelectric threshold low 518 value, the program storage 519, the blackout periods 520 index, the voltage primary battery 522 value, and one or more of the harvesting levels 523, 524, 525 values. The controller system 500 then may assess the condition of the electronic device compared to end of life criteria at step 538. Step 538 may include assessing at least one of use the counter 508 that counts the number of user interactions, the usage time 509 that reports the time the display has been on, the maximum number of interactions 510 value or the contractual life of the device 511 value. A test is conducted to assess if the device is at the end of life at step 539. If at step 539 it is determined that yes, the device is at the end of life, the elements of the display(s) are marked according to the routine in step 540. The routine in step 540 may be a function of the display status 512, the coloring voltage high 513 value, the coloring voltage low 514 value, the number of elements 531, the line resistance element 532 value, and the area element 533. If at step 539 it is determined that no, the device is not at the end of life, a subroutine is called for to update counters, compute the waveform parameters and drive the different connections between controller system and display at step 541. Step 541 may include at least one of the following: incrementing the display status if the display status 502 indicates that the display is not “programmed” or “end of life operation;” starting a lifetime clock 527 if the display system status 502 is “laminated;” starting a status specific timer depending on the status of one or more of the lamination timer 503 or the programming timer 504; updating the usage counter 508; updating the usage time 509; invoking a user application; invoking a delay, which may be a function of the harvesting processing 515 status, the voltage threshold low 516 value, the current threshold low 517 value, the piezoelectric threshold low 518 value, the program storage 519 status, or the energy available 526 value; invoking elements to color, which may be a function of elements to limit end of life 507, number of elements 531, or a user application; waiting for delay, which may be a function of timer 528; for each of the N elements of the number of elements 531, invoking a set waveform, which may be a function of the display status 512, the coloring voltage high 513 value, the coloring voltage low 514 value, the number of elements 531, the line resistance element 532, and the area element 533. The time and date at which step 541 is performed may be recorded in memory bank 529. At step 542, the controller system may be placed into sleep mode while awaiting the next interrupt.

The specific embodiments illustrated in FIGS. 1, 2, 3, 4a, 4b, 5a and 5b are exemplary. The components, instructions and functions encoded on an electronic device may vary. As used herein, the term “electronic system” refers to an electronic device and the associated power source for the electronic device. For electronic devices having no remote power source, the electronic system is the electronic device with one or more individual power source embedded on or in the electronic device. For electronic devices having a remote power source, the electronic system is the electronic device with one or more energy harvesting components, one or more individual remote power sources, and if present one or more individual power sources embedded on or in the electronic device. Embodiments herein include the exemplary embodiments, methods related to the exemplary embodiments, modifications of the exemplary embodiments, and methods related to modifications of the exemplary embodiments. The features below may be incorporated into an electronic device or electronic system based on the exemplary embodiments or modifications thereof.

As described with respect to FIGS. 4b and 5b, one or more waveforms may be produced where a waveform is intended for an individual addressable element. A collection of the one or more waveforms for respective individually addressable elements may be referred to as a waveform set.

The controller system may manage system power consumption. One way to manage power consumption is through a combination of waveform parameter control and selection of power source. The management may be based on one or more of the following: the status of the power source, the life-cycle status of the system, the status of the display, and the status of an interaction with system.

As described above, a waveform may be generated by the controller system and received by the display. The waveform shape may include delaying the coloring and/or discoloring of elements display. The waveform control may include letting specific segments be discolored. A waveform control may include letting specific segments be colored. The waveform control may include not refreshing specific segments. A waveform may be applied to an individual segment(s) of display. A waveform may be unipolar. A waveform may be tristate. A waveform may include a high voltage, a low voltage and a floating voltage. A waveform may include a high voltage, a low voltage and a null voltage. When a waveform is unipolar or tristate, the controller system may utilize port polarity inversion to create elements of the waveform.

The status of the associated power source or any individual power source may be arrived at by a measure of any parameter affecting the system. The status of an associated power source or any individual power source may be at least one of the following conditions: presence of at least one of the power sources in proximity to the electronic device (this could be detected by sensing an output from one or more specific harvesting components); distance of at least one of the power sources to the electronic device (this could be measured by a roundtrip estimated by a reader and transmitted to the electronic device); efficiency of harvesting from at least one of the power sources (this could be detected by measuring the output of a specific harvesting component; e.g., the current of a solar cell for detecting light, or the rectified voltage of a diode bridge for detecting Radio Waves); comparison of at least one of the power sources voltage to one or more set voltage levels stored in memory; comparison of at least one of the power sources current to one or more set amperage levels stored in memory; or comparison of at least one of the power sources energy (estimated by say samples of voltage times current accumulated over a said period) to one or more set energy levels stored in memory. These conditions may be processed by the controller system to decide what waveform set should be applied to the display.

An electronic device may include a life cycle status. The life cycle status may include an indication of the electronic device progress through the electronic device life cycle. The life cycle status may include a measure of a electronic device parameter at a point in the system progress through the system life cycle. The life cycle status may be but is not limited to at least one of the following conditions: interconnection of a power source(s) to the electronic device; encapsulation of the electronic device and any embedded individual power source(s) and/or energy harvesting component(s) (this could be detected using a temperature sensor or starting a timer before lamination is started where the timer is set to a value larger than the lamination processing time); lamination of the electronic device and any embedded individual power source(s) and/or energy harvesting component(s) as part of a second system; pre-lamination of the electronic device and any embedded individual power source(s) and/or energy harvesting component(s) as part of a second system; post-lamination of the electronic device and any embedded individual power source(s) and/or energy harvesting component(s) as part of a second system; programming of the electronic device; or the number of user interactions (e.g., the number of times a user presses a button, the number of times a user presses buttons in a specific order, the number of times a card is refilled, the number of times a magnetic strip is read, etc.). The number of user interactions could be compared to a specific number or subset of interactions set within the electronic device. The subset of interactions set within the system may be stored in non-volatile memory inside with the controller system. Additional examples of a life cycle status include but are not limited to a timer expiring or specific point in time (this can be managed using a real time clock inside the controller system). The different life-cycle status conditions can be stored into non-volatile (for instance FLASH, EEPROM) inside the controller system. In response to a life cycle status, an application specific action may be implemented. The application specific action may be but is not limited to at least one of burnout of the display at end of life (e.g., end of life may be when the energy (mAh) hour available is insufficient to perform intended processes); burnout of the display at end of contractual period; continue normal operation when card re-filled; prevent information display if the wrong key sequence pressed, the wrong proof of identity provided or credential revoked; change background color of display to indicate being in a particular (e.g., restricted) area; or permanently burn only some elements of display indicating that the device has been in an out of range condition (e.g., temperature, pressure, place, distance from base).

An electronic device or electronic system may be part of (e.g., integrated in) a second system. The second system may include, but is not limited to the following:

1) Smartcards, bankcards and transit cards where a microcontroller system stores information that may include, but is not limited to, password, balance, and transaction information. This information may be displayed when the user presses a button and when authorized through an RFID like challenge response from a reader.
2) Labels and tags where pricing information is broadcasted in a background manner from a central transmitter to a series of tags where the information is stored in a microcontroller for display. In some cases, the power to the tag is provided through RF broadcast or through solar cell also part of the tag.
3) Disposable sensors where sensed information may include but is not limited to information regarding a chemical, a pathogen, and temperatures is sensed on a regular basis (through clocked software running on a controller system) with a series of one or more analog or digital sensors).
4) Security badges or passports where information including, but not limited to, biometric information may be used to trigger interactions (e.g., scanning of a thumb print), DNA match (e.g., analysis of a user saliva) or used to reinforce and complement another indicator (other indicators contemplated include, but are not limited to, showing the face of an employee on a badge when that employee is authorized to be in a specific area).

An electronic device may include user input devices, which may be of any type. An input device may be a button, series of buttons or a miniature keyboard. An input device may be a microphone. An input device may be a piezoelectric transducer. An input device may be chemical sensor. An input device may be a magnetic switch. An input device may be operably connected to the controller system.

An electronic device may include an interaction status. The interaction status may by a report of any type of interaction with the system. The interaction status may include at least one of the following conditions: history of interactions, amount of time since specific interaction, or a type of interaction. The different life-cycle status conditions can be stored into non-volatile (for instance FLASH, EEPROM) inside the controller system. Interactions that may be the object of an interaction status may be but are not limited to at least one of the number of times a device has been used to gain access (e.g., to public transportation, to theatre, to secured areas); specific locations visited (e.g., locations at an amusement park, buildings, streets, states); number of times a card has been swiped; number of times a button pressed; number of times a code entered; number of times an item price has been reduced; number of times a temperature has been achieved or passed; number of times the card has been placed close to an NFC reader; or number of times a card has been left outside (e.g., in the sun). In response to an interaction status, an application specific action may be implemented. The application specific action may be but is not limited to revoking privilege; revoking permission to access; raising price; or signaling a secondary system regarding the interaction status.

It is desirable that display control electronics within an electronic device operate efficiently to enable sufficient lifetime of the electronic device or system. For disposable systems or disposable electronic devices, the electronics may be configured for a lifetime to end at the time of disposal, or to end in order to trigger disposal (or end of use).

The manufacturing of electronic devices or electronic systems using printing might result in individual electronic devices, electronic systems or components therein with significant differences in electro-optic responses. Embodiments herein may be provided in printed electronic devices or systems to extend or monitor the life of the electronic device or system.

When an electronic device is printed, the manufacturing process may impact performance of the power source for an electronic device. In the case of smartcards for instance, the battery performance parameters (e.g., say total energy available, voltage provided, amount of current available) vary after final assembly. This may occur whether the battery is a primary (not rechargeable) or secondary (rechargeable) battery.

Some electronic devices or systems include a non-consistent power source. This may occur (but not necessarily) as the result of a power source based on a harvesting technology. For instance, power may be harvested by a solar cell. For non-consistent power sources, the amount of current available to control the display may vary. Embodiments herein may be utilized to control electronic devices or systems having non-consistent power source. The control may be utilized to stabilize the power use, or maximize the system or display life.

Multiple power sources can be used in electronic devices or systems. The potential for multiple power sources is being exploited for sensors (see, for instance, Texas Instrument's eZ430-RF2500-SEH system, which is incorporated herein by reference as if fully set forth). Often, secondary batteries (batteries that can be recharged) or supercapacitors (referred to at times as super cap) are used as integrate the energy harvested. The integration of a primary battery with a Radio-Frequency (RF) harvester results in a non-consistent power source. Wireless coupling may be provided in embodiments herein (See Dahl, U.S. Pat. No. 3,938,018, which is incorporated herein by reference as if fully set forth).

Many systems leveraging printed displays have a finite life and thus may rely on a adaptation, perhaps even constant adaptation, of the power management to the position a device is at within its lifecycle. Embodiments herein provide adaptation of power management in a system or display. Embodiments herein provide constant adaptation of power management in a system or display.

Printed displays may be realized on plastic or paper substrates. Embodiments herein include printed displays. Such a display may be cost effective. The level of protection of the display against oxygen and water vapor ingress may not be as effective as the glass born displays of other technologies. This can translate in different electro-optical behavior. Embodiments herein provide electronic devices or systems that have a sensor(s) that can monitor oxygen and/or water vapor ingress operably connected to the controller system, which can then adapt thereto. Embodiments herein include a display or system with a driver scheme adapted to change display or system parameters in response oxygen and/or water vapor ingress. This adaptation may be in the form of reduced or increased refresh rate of displays between user initiated usage.

An electronic device may include a sensor that senses the source voltage or current. Based on the source voltage or current, a controller system may change the way it controls changes in the display. The sensor may include but is not limited to a current sense resistor, an analog to digital converter (ADC), a voltage divider, simple diode detector, or any other sensing device. The voltage divider may be but is not limited to a capacitive divider. Source voltage sensed may drop under integration of the system, use, temperature, lamination and/or aging. As the source voltage changes, the display waveform may be adjusted by using a waveform (i.e., signaling) for each data lead to the display. Adjustment of the waveform may be made by the controller system in response to signals received by the sensor. The controller system may apply the waveform to the display. The controller system may change its behavior as soon as possible in the lifecycle.

An important class of low power displays is the class of bistable displays, which only change the state of the display from non-colored to colored or from colored to non-colored. Bistability allows for special driving schemes (See Admundson et al., U.S. Pat. No. 7,733,311, which is incorporated herein by reference as if fully set forth) akin to the selective replenishment techniques of video compression. A subclass of such displays requires only power to color the display, relying on a natural discoloring.

An important class of bistable displays is the class of electrochromic displays. Electrochromism has been used for mirrors, windows, light modulators and display/electronics paper systems (See P. M. S Monk, R. J. Mortimer, and D. R. Rosseinsky, Electrochromism and Electrochomic Devices, ISBN 978-0-521-82269-5, 2007, which is incorporated herein by reference as if fully set forth). The electro-optical effects can be bistable (where an image is retained on the display until forced to disappear), self-erasing (where an image disappears shortly after the application of charge), or permanent (where an image appears and lasts forever after the application of a charge). The electro-optic effects of these electrochromic displays may be based on reduction effect (where electrons are being provided to a chromophore structure) or oxidation effect (where electrons are being removed from the chromophore structure) such as those displays disclosed in U.S. Pat. Nos. 6,301,038 and 6,870,657, both of which are incorporated herein by reference in their entirety as if fully set forth.

A sandwich architecture is discussed by Fitzmaurice et al., U.S. Pat. No. 6,301,038, which is incorporated by reference herein as if fully set forth. The sandwich architecture includes two substrates. It also includes high surface area nanoporous electrochromic films. An advanced design supporting reflective and emissive designs using a sandwich architecture is disclosed in Mizuno et al., U.S. Pat. No. 7,184,191, which is incorporated herein by reference as if fully set forth. The design in Mzuno et al. includes a working side with two electrodes, one that emits light, one that reflect light. The substrates used are covered with transparent conductors.

In U.S. Pat. No. 7,460,289, which is incorporated herein by reference as if fully set forth, Pichot et al. introduced a monolith (single substrate) structure where a single substrate is used. The counter electrode (also referred to as the COM electrode, for common) is printed first on the substrate, then a separator, then a working electrode. The working electrode has a single non-patterned conductor buried in its structure. Improvement on this concept has been developed by Leyland et al., in PCT/US2008/065062, which is incorporated herein by reference as if fully set forth. The architecture in Leyland et al. is referred to as COM on substrate.

Another single substrate monolith architecture, referred to as SEG on substrate (as in segmented electrode relating to the area of the working electrode that changes color through the redox process) is described in Briancon et al., PCT/US2009/056162, which is incorporated herein by reference as if fully set forth. In this application, a conductor is applied directly between the substrate supporting the working (typically segmented, thus SEG) SEG electrode, and the SEG electrode.

A fourth type of architecture was recently disclosed in PCT/US2009/056162, which is incorporated herein by reference as if fully set forth. In this architecture, a porous substrate is used inside the structure itself, and because the substrate is porous, electrolyte permeates through it. While developed for displays applications, nothing precludes it from being used for the other classes of devices, once a porous substrate can be made transparent. This architecture is referred to as substrate as SEP (for separator).

Another class of display technologies that can be used includes those utilizing electro-optic effects created by change in pH level and those that utilize halochromic effects where protons are generated or removed as disclosed in U.S. Pat. Nos. 6,879,424 and 7,054,050, which are incorporated herein in their entirety as if fully set forth. Display/color change effect can also take place through ionochromic effect in the systems described herein. Electrophoretic displays (see U.S. Pat. No. 7,580,025, which is incorporated herein in its entirety as if fully set forth) and LCD displays can also be used.

Embodiments herein provide electronic devices adapted to include any kind of display, including but not limited to photochromic, thermochromic, tribochromic, piezochromic, solvatochromic, halochromic, electrochromic, electrophoretic or electro-wetting displays. Embodiments herein provide electronic devices adapted to include any kind of display, including but not limited to ones such as those described in the paragraphs above. In an embodiment, the electrochromic display may not require special analog circuitry to operate properly. The electrochromic display may be controlled through digital devices with serial interface such as SPI, I2C, GPIO and operate at voltages as low as 1V. The display segments may be burned in through overvoltage or overdriving. The display may also have a capacitance to store a high amount of charge by area. The high amount of charge needed to color an area may be in the range of 2 to 4 milli-coulombs per cm². In applications that use a simple power source (for example but not limited to, a battery), it may not be feasible to include multi-level system voltages, as this is would incur an undesired cost and power drain. The system may utilize port polarity inversion to allow the display to be discolored with an over potential. The port polarity inversion is supported by most digital chips and may be controlled by writing into the appropriate memory register.

Additional power savings can be accomplished when bistable or nearly bistable displays are used and embodiments include such displays in an electronic device herein. Bistable displays are those displays that keep an image permanently with no power consumption after an image transition. Nearly bistable (or metastable) displays exhibit a slow reversible bleaching, albeit at a time frame longer than the typical use of the display. In such a case whenever an icon or segment is not changed (XOR (new segment, old segment))=0, the corresponding PIN is kept in high impedance. This creates a control waveform that is tri-state (high voltage for coloring, short for discoloring, and high impedance (floating voltage) to keep color. This waveform can be thought as an extension of the traditional unipolar pulse width modulation and dubbed extended pulse width modulation (EPWM).

Power source characteristics could be mapped in drive software such that the output over the operational lifetime of the application (whether as a function of time or number of uses of the system) can be tuned to match the source characteristics. Further, the software can also map features of the display, such as individual pixel impedances or aging characteristics of the display, to modulate drive waveforms for optimal power savings and system performance.

The number of digits or segments driven by the drivers could be reduced under low power conditions. This may be helpful, for instance, in the case of a temperature logger. As the voltage level is reduced the right most significant digits could be turned off. In the case of the system is embedded in a second system, the second system may bear instructions that the absence of specific digits means those digits are in fact zero. This is an example of tight coupling between the display status and power status.

The number of digits or segments driven by the drivers could be altered based on the time of the day, day of the week. This may be especially helpful for smart labels that are not used outside of business open hours. This is an example of tight coupling between the application status and display status.

It may be possible to maintain a constant response to the user of the display in an electronic device by using EPWM at the start of life to extend the drive time and extend the pulse width over time as the source amplitude drops in order to maintain a constant (or near constant) equivalent display response. The control waveform may be different for each segment or icon of the display. It may be possible to create a controllable response over the lifetime of the display by including an end-of-life routine that can monitor the source voltage and stop display operation when the supply characteristics become too low to provide satisfactory display response. Alternatively, the end-of-life routine can fix the number of cycles of operation and then cause a system event. The system event may be but is not limited to a software controlled stop or burn-in of one or more of the display elements.

In an embodiment, the controller system could be placed in a high impedance state that reduces the risk of power drains caused by the display being activated during a lamination processes. The system may be removed from this state by various means including an RF signal or a timer. The system may be configured to look up tables of values to modulate the drive characteristics before and after processing. This may be done to account for changes that occur during intensive processing steps, which may be but are not limited to high temperature or pressure lamination. Similarly, the system may be forced into a known state (e.g., bleached state) upon application boot or system resets to ensure no open ports are drawing current. Refresh algorithms may be utilized using onboard timers or synchronised with an RF signal or onboard photo sensors that update the display when power is available, for example when light is present to activate a photovoltaic source or when an RF signal is strong enough to provide proper colouration of the display. Multiple power sources may also be utilised on board the system in order to scavenge power when available and use sources in the most efficient manner by monitoring the source characteristics.

In an embodiment, a test system may be embedded in the display driver that saves production costs and may also serve to self-select bad parts. Such an electronic device may utilize test routines to drive and then sample pixel response to verify correct behavior (examples of correct behavior include but are not limited to contrast ratio achieved after sending a constant voltage waveform (DC) for a given amount of time). Such an arrangement could be achieved by using a GPIO, analog sampling input modes or Schmitt trigger inputs.

As described above, multiple sources of power may be used in conjunction with one another in the associated power source. The associated power source may include a rectified power based Radio-Frequency (RF). This could be a Near Field Communication (NFC), Bluetooth™, RFID, Zigbee™, ZigWave™, or IEEE 802.11 based system. The signal amplitude may vary depending on the environment and/or distance between the transmitter and device, and thus the power source characteristics may not be predictable. The associated power source may also include a charge capture device. The charge capture device may be but is not limited to a second battery, a supercapacitor or an electrochromic display. Source mapping includes the use of higher amplitude source properties managed through EPWM, which may enable optimal use of a variety of sources, particularly sources such as RF signals that can vary in amplitude depending on the environmental conditions and distance from the transmitter.

Delaying the coloring of the display is used in an embodiment. This may be done for a variety of conditions. Delaying the coloring of the display may be utilized to allow energy harvesting (e.g., RF, light, mechanical/piezoelectric) to power the display device.

In an embodiment, the capacitance of the display element can be used for an additional function or the display materials can be used for its capacitive properties, particularly displays with large capacitance (e.g., electrochromic displays). Such functionality may be the use of the capacitance as a charge-pump capacitor, a resonator or as a charge reservoir on a power line. Additionally, a combined battery-display system can be used to provide power for additional sub modules of the printed system.

In an embodiment, ports or logic may be configured to switch power between switching pixels and/or a charge reservoir such as a capacitor, supercapacitor or battery so as to reuse the charge stored on the pixels.

As described above, an electronic device may be part of an electronic system. The skilled artisan will recognize that an electronic device as described above may be provided as a unit having its power sources therein and/or energy harvesting components therein. In addition, the power sources or energy harvesting components herein may be operably connected the other components of the electronic device as described above. Embodiments herein include an electronic device as described above with one or more power source embedded in or on the electronic device. Embodiments herein include an electronic device as described above with one or more energy harvesting components. Embodiments herein include an electronic device as described above with one or more energy harvesting components and one or more power source embedded in or on the electronic device.

An embodiment includes a computer-readable medium storing a set of instructions, where the set of instructions includes instructions to implement a method described herein. An embodiment includes a computer-implemented method of controlling an electronic device as described herein. Instructions to implement the systems, methods, or electronic devices described herein may be embodied as computer-readable instructions, data structures, program modules, or other data in a modulated data signal such as a carrier wave, data signal, or other transport mechanism and includes any information delivery media.

In the above embodiments, instructions for producing a waveform set may include at least one of instructions for selecting a waveform set from a waveform set database, selecting individual waveforms from an individual waveform database, creating one or more waveform, or any combination thereof. Waveform set and individual waveform sets may be stored in the computer-readable medium. Instructions for creating one or more waveform may be stored in the computer-readable medium.

The references cited throughout this application, are incorporated for all purposes apparent herein and in the references themselves as if each reference was fully set forth. For the sake of presentation, specific ones of these references are cited at particular locations herein. A citation of a reference at a particular location indicates a manner(s) in which the teachings of the reference are incorporated. However, a citation of a reference at a particular location does not limit the manner in which all of the teachings of the cited reference are incorporated for all purposes.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. An electronic system comprising:
an electronic device having a controller system and a display including at least one addressable element; and an associated power source including at least one individual power source; the display operably connected to the controller system, and the associated power source operably connected to the controller system;
the controller system including a processor and a computer-readable medium, the processor operably connected to the computer-readable medium, the computer-readable medium having processor executable instructions for: determining at least one status selected from the group consisting of life-cycle status of the electronic device, status of the display, and status of an interaction with the electronic device; producing a waveform set having one or more individual waveforms based on at least one of the life-cycle status of the electronic device, the status of the display, or the status of an interaction with the electronic device; and applying the waveform set to the display.

2. The electronic system of claim 1, wherein each of the at least one individual power source are embedded on or in the electronic device and are selected from the group consisting of a primary battery, a secondary battery, a capacitor, a piezoelectric cell, and an electrochemical system.

3. The electronic system of claim 1 further comprising a sensor operably connected to the controller system and one or more of the at least one individual power source and capable of detecting at least one of voltage or current from the associated power source; and the computer-readable medium further including instructions for determining a status of the associated power source based on the sensor and modifying the waveform set based on the status of the associated power source by at least one of substituting at least one of the one or more individual waveforms with one or more different waveforms from a waveform database, substituting the waveform set with a different waveform set from a waveform set database or changing parameters of at least one of the one or more individual waveforms based on the status of the associated power source.

4. The electronic system of claim 1, wherein the status of the associated power source includes at least one condition selected from the group consisting of presence of an individual power source in proximity to the electronic device, distance of an individual power source in proximity to the electronic device, efficiency of harvesting from an individual power source, a voltage relationship between a voltage of one or more individual power source in combination compared to a controller system specified voltage, a current relationship between one or more individual power source in combination compared to a controller system specified current, and an energy relationship between an energy level of one or more individual power source in combination compared to a controller system specified energy level.

5. The electronic system of claim 1, wherein the electronic device further includes at least one energy harvesting component, the at least one energy harvesting component capable of being operably connected to a respective individual power source not on the electronic device.

6. The electronic system of claim 1 further comprising a clock.

7. The electronic system of claim 1, wherein instructions for applying the waveform set include delaying at least one of coloring or discoloring the at least one addressable element.

8. The electronic system of claim 1, wherein instructions for applying the waveform set include letting specific elements of the display be discolored or letting specific elements of the display be colored.

9. The electronic system of claim 1, wherein instructions for applying the waveform set include not refreshing specific elements of the at least one addressable element.

10. The electronic system of claim 1, wherein instructions for applying the waveform set include instructions for assigning one of the one or more individual waveforms to an individual addressable element of the at least one addressable element.

11. The electronic system of claim 1, wherein a waveform of the one or more individual waveforms is unipolar and the instructions for producing the waveform includes instructions directing the controller system to create elements of the waveform by port polarity inversion.

12. The electronic system of claim 1, wherein a waveform of the one or more individual waveforms is tristate and includes a high voltage, a low voltage and a floating voltage, and the instructions for producing the waveform include instructions directing the controller system to create elements of the waveform by port polarity inversion.

13. The electronic system of claim 1, wherein the life cycle status includes at least one condition selected from the group consisting of interconnection of an individual power source in the system, encapsulation of the electronic device, lamination of the electronic device as part of a second system, pre-lamination of the electronic device as part of a second system, post-lamination of the electronic device as part of a second system, post-integration of the electronic system as part of a second system, programming, a number of interactions with the electronic device, a number of a specific subset of interactions with the electronic device, and an amount of time since a specific event.

14. The electronic system of claim 1, wherein the interaction status includes at least one condition selected from the group consisting of history of interactions, amount of time since a specific interaction, and type of interaction.

15. A method of managing power consumption in an electronic system having an associated power source including at least one individual power source and an electronic device, the electronic device having a display and a controller system, the display operably connected to the controller system and the controller system operably connected to the associated power source, the display having at least one addressable element, and the control system including a processor and a computer-readable medium having processor executable instructions for conducting the method, the processor operably connected to the computer readable-medium; the method comprising:
determining at least one status selected from the group consisting of life-cycle status of the electronic device, status of the display, and status of an interaction with the electronic device;
producing a waveform set having one or more individual waveform based on at least one of the life-cycle status of the electronic device, the status of the display, and the status of an interaction with the electronic device;
applying the waveform set to the display.

16. The method of claim 15, wherein producing the waveform set includes delaying at least one of coloring or discoloring of the at least one addressable element.

17. The method of claim 15, wherein producing the waveform set includes letting specific elements of the display be discolored or letting specific elements of the display be colored.

18. The method of claim 15, wherein producing the waveform set includes not refreshing specific elements of the at least one addressable element.

19. The system of claim 15, wherein applying the waveform set includes assigning a waveform in the waveform set to an individual addressable element of the at least one addressable element.

20. The method of claim 15, wherein producing the waveform set includes creating a unitary or tristate waveform by port polarity inversion.

21. The method of claim 15, wherein the determining step further includes determining a status of the associated power source including at least one condition selected from the group consisting of a voltage or current from the associated power source, presence of an individual power source in proximity to the electronic device, distance of an individual power source in proximity to the electronic device, efficiency of harvesting from an individual power source, a voltage relationship between a voltage of one or more individual power source in combination compared to a controller system specified voltage, a current relationship between one or more individual power source in combination compared to a controller system specified current, and an energy relationship between an energy level of one or more individual power source in combination compared to a controller system specified energy level; and the producing a waveform set step further based on the status of the associated power source.

22. The method of claim 15, wherein the life cycle status includes at least one condition selected from the group consisting of interconnection of an individual power source in the system, encapsulation of the electronic device, lamination of the electronic device as part of a second system, pre-lamination of the electronic device as part of a second system, post-lamination of the electronic device as part of a second system, integration of the electronic system as part of a second system, programming, a number of interactions with the electronic device, a number of a specific subset of interactions with the electronic device, and an amount of time since a specific event.

23. The method of claim 15, wherein the interaction status includes at least one condition selected from the group consisting of history of interactions, amount of time since a specific interaction, and type of interaction.

24. An electronic device comprising:
a controller system, a display including at least one addressable element, and at least one of a power source or an energy harvesting component; the display operably connected to the controller system, and at least one of the power source or energy harvesting component are operably connected to the controller system;
the controller system including a processor and a computer-readable medium, the processor operably connected to the computer-readable medium, the computer-readable medium having instructions for: determining at least one status selected from the group consisting of life-cycle status of the electronic device, status of the display, and status of an interaction with the electronic device; producing a waveform set having one or more individual waveforms based on at least one of the life-cycle status of the electronic device, the status of the display, and the status of an interaction with the electronic device; and applying the waveform set to the display.

25. The electronic device of claim 24 further comprising a sensor operably connected to the controller system and one or more of the power source and the energy harvesting component, the sensor capable of detecting at least one of voltage or current from at least one of the power source or the energy harvesting component; and the computer-readable medium further including instructions for determining a status of the one or more of the power source or the energy harvesting component based on the sensor and modifying the waveform set by at least one of substituting at least one of the one or more individual waveforms with one or more different waveforms from a waveform database, substituting the waveform set with a different waveform set from a waveform set database or changing parameters of at least one of the one or more individual waveforms based on the status of the associated power source.

26. The electronic device of claim 24, wherein the status of the power source includes at least one condition selected from the group consisting of presence of an off-device power source in proximity to the electronic device, distance of an off-device power source in proximity to the electronic device, efficiency of harvesting from an off-site power source, a voltage relationship between a voltage of at least one of the power source or energy harvesting component compared to a controller system specified voltage, a current relationship between at least one of the power source or energy harvesting component compared to a controller system specified current, and an energy relationship between at least one of the power source or energy harvesting component compared to a controller system specified energy level.

27. The electronic device of claim 24 further comprising a clock.

28. The electronic device of claim 24, wherein instructions for applying the waveform set include delaying at least one of coloring or discoloring of the at least one addressable element.

29. The electronic device of claim 24, wherein instructions for applying the waveform set include letting specific elements of the display be discolored or letting specific elements of the display be colored.

30. The electronic device of claim 24, wherein instructions for applying the waveform set include not refreshing specific elements of the at least one addressable element.

31. The electronic device of claim 24, wherein instructions for applying the waveform set include instructions for assigning a waveform of the waveform set to an individual addressable element of the at least one addressable element.

32. The electronic device of claim 24, wherein a waveform of the one or more individual waveforms is unipolar and the instructions for producing the waveform include instructions directing the controller system to create elements of the waveform by port polarity inversion.

33. The electronic device of claim 24, wherein a waveform of the one or more individual waveforms is tristate and includes a high voltage, a low voltage and a floating voltage, and the instructions for producing the waveform include instructions directing the controller system to create elements of the waveform by port polarity inversion.

34. The electronic device of claim 24, wherein the life cycle status includes at least one condition selected from the group consisting of interconnection of an off-device power source to the energy harvesting component, encapsulation of the electronic device, lamination of the electronic device as part of a second system, pre-lamination of the electronic device as part of a second system, post-lamination of the electronic device as part of a second system, integration of the electronic device as part of a second system, programming, a number of interactions with the electronic device, a number of a specific subset of interactions with the electronic device, and an amount of time since a specific event.

35. The electronic device of claim 24, wherein the interaction status includes at least one condition selected from the group consisting of history of interactions, amount of time since a specific interaction, and type of interaction.
